(19) United States
(12) Patent Application Publication
(10) Pub. No.: US 2014/0192525 A1
(43) Pub. Date: Jul. 10, 2014

(54) LIGHT PROJECTION DEVICE

(71) Applicant: Panasonic Corporation, Osaka (JP)

(72) Inventors: Erika Kawabata, Kyoto (JP); Katsushi Sumisaki, Osaka (JP)

(73) Assignee: Panasonic Corporation, Osaka (JP)

(21) Appl. No.: 14/240,777

(22) PCT Filed: Sep. 25, 2012
(86) PCT No.: PCT/JP2012/006072

§ 371 Date: Feb. 25, 2014

(30) Foreign Application Priority Data
Oct. 7, 2011 (JP) 2011-222492

(51) Int. Cl. F21V 7/10

(52) U.S. Cl. CPC F21V 7/10
USPC 362/217.05

(57) ABSTRACT

A light projection device of the present invention includes a flash discharge tube and a reflector into which the flash discharge tube inserted. The reflector is composed of at least a first reflector and a second reflector. At least a joint between the first reflector and the second reflector is fixed with a conductive fixing material. This structure prevents looseness between the first reflector and the second reflector and facilitates positioning between them. Further, the first reflector and the second reflector are reliably fixed at the same electrical potential to prevent sparks, thereby providing a light projection device capable of achieving stable optical performance.

### TECHNICAL FIELD

The present invention relates to a light projection device that irradiates light toward an irradiation target body.

### BACKGROUND ART

A variety of light projection devices have been devised such as a strobe device as a representative example.

A typical strobe device includes a flash discharge tube and a reflector into which the flash discharge tube is inserted. A trigger voltage applied to the flash discharge tube makes the flash discharge tube emit radiation light. Radiation light radiated from the flash discharge tube is directly irradiated toward an irradiation target body; reflected light (i.e., radiation light from the flash discharge tube that has been reflected on the reflector) is also irradiated toward the irradiation target body. For the reflector, the following structure has been devised.

First, a strobe device is disclosed where the reflector is divided to allow the irradiation angle to be variable by changing the position and direction of the respective reflectors (refer to patent literatures 1 and 2 for instance).

Another strobe device is disclosed where the reflector works as trigger electrodes to make the flash discharge tube emit light with a trigger voltage applied to the reflector applied to the flash discharge tube through the reflector (refer to patent literature 3 for instance).

Besides strobe devices, a light projection device has been patent applied that irradiates light uniformly toward an irradiation target body with a certain degree of breadth, such as a device that irradiates light onto the palm and back of a hand to prevent and heal rough, red hands.

For the above-described light projection device, light from the flash discharge tube needs to be extensively distributed, and thus a reflector is used that has a large (long) depth (the direction in which light is irradiated). In this case, the above-described reflector may be divided for the reasons of molding and machining, where its purpose is different from that of the reflector of the strobe device in patent literature 1 and 2.

When the reflector is divided, however, variations in the dimensions of the respective reflectors for instance cause a gap in the joint between the reflectors. The gap undesirably causes looseness between the reflectors and makes positioning between them difficult. Consequently, the light projection device cannot achieve the optical performance meeting the specifications required for a normal light projection device and is handled as a defective product, which undesirably decreases yields.

Meanwhile, when the reflector is divided and is used as trigger electrodes, a gap formed in the joint between the reflectors generates potential differences between them. In this case, applying a trigger voltage to the reflectors as trigger electrodes may generate a spark, which undesirably impairs the optical performance required for a normal light projection device and damages the flash discharge tube.

### CITATION LIST

### Patent Literature

PTL 1 Japanese Patent Unexamined Publication No. H03-100536
PTL 2 Japanese Patent Unexamined Publication No. 2007-199167
PTL 3 Japanese Patent Unexamined Publication No. 2004-279577

### SUMMARY OF THE INVENTION

To solve the above-described problems, a light projection device of the present invention includes a flash discharge tube and a reflector into which the flash discharge tube inserted. The reflector is composed of at least a first reflector and a second reflector. At least a joint between the first and second reflectors is fixed with a conductive fixing material.

This structure prevents looseness between the first reflector and second reflector and facilitates positioning between them, thereby providing a light projection device capable of achieving stable optical performance.

### BRIEF DESCRIPTION OF DRAWINGS

FIG. 1 is an entire perspective view of a light projection treatment and prevention device according to a first exemplary embodiment of the present invention.

FIG. 2 is a substantial part sectional view of the light projection treatment and prevention device according to the same exemplary embodiment.

FIG. 3 is a block diagram of the light projection treatment and prevention device according to the same exemplary embodiment.

FIG. 4 is a perspective view of the reflector of the light projection treatment and prevention device according to the same exemplary embodiment.

FIG. 5A is a side view of the reflector of the light projection treatment and prevention device according to the same exemplary embodiment.

FIG. 5B is a sectional side view of the reflector of the light projection treatment and prevention device according to the same exemplary embodiment.

FIG. 6 is an exploded perspective view of the reflector of the light projection treatment and prevention device according to the same exemplary embodiment.

FIG. 7A is an entire perspective view of the reflector of a light projection treatment and prevention device according to a second exemplary embodiment of the present invention.

FIG. 7B is a cross-sectional side view of the light projection treatment and prevention device, illustrating a state where the reflector is accommodated in the casing according to the second exemplary embodiment.

FIG. 8A is a perspective view of a cap used for a light projection treatment and prevention device according to a third exemplary embodiment of the present invention.

FIG. 8B is a cross-sectional side view of the cap used for the light projection treatment and prevention device according to the third exemplary embodiment.

### DESCRIPTION OF EMBODIMENTS

Hereinafter, a description is made of a light projection device according to some exemplary embodiments of the present invention with reference to the related drawings. The scope of the present invention is not limited to the exemplary embodiments. The following description is made of a light projection treatment and prevention device as an example of a light projection device of the exemplary embodiments.

### First Exemplary Embodiment

Hereinafter, a description is made of a light projection treatment and prevention device, which is an example of a light projection device according to an exemplary embodiment of the present invention.

First, a description is made of the effects of inflammatory cytokine, the production of which is suppressed by a light projection treatment and prevention device according to the exemplary embodiment.

Inflammatory cytokine is a type of cytokine, which is the generic name for soluble proteins that carry various types of intercell information in the living body. Inflammatory cytokine especially contributes as a causative factor that causes a variety of inflammatory symptoms in the living body and is produced from activated macrophages and activated vascular endothelial cells.

Concretely, representative examples of inflammatory cytokine verified by experiments and other means include hVEGF (vascular endothelial growth factor), TNFα (tumor necrosis factor-α), IL-1β (interleukin-1β), IFNγ (interferonγ), IL-6 (interleukin-6), and IL-12a (interleukin-12a).

While multiple types of cytokine are forming complicated networks in the living body, inflammatory cytokine exhibits directional activity as a whole. In other words, an imbalance between inflammatory cytokine and active anti-inflammatory cytokine, which is produced from blood cells as well and prevents inflammation, induces an excessive disease of the inflammatory reaction.

Some experiments and other means have proved that IL-4 (interleukin-4), a type of anti-inflammatory cytokine, is not effective in preventing the production of inflammatory cytokine.

The applicant of this invention, however, has discovered that the above-described inflammatory cytokine reduces the production amount of hVEGF at a specific wavelength of irradiation light (radiation light) irradiated from a discharge tube for instance more strongly than at the other wavelengths.

Concretely, comparison has been made as follows. That is, irradiation light emitted from a xenon discharge tube is irradiated onto human epidermal cells. The irradiation light is dispersed according to each given center wavelength using a band pass filter with a half band width of 40 nm. The production amount of hVEGF is compared by center wavelength. The comparison result shows that the production amount of hVEGF is at the minimum between a center wavelength of 600 nm and that of 700 nm.

In the same way, comparison has been made as follows. That is, irradiation light emitted from a xenon discharge tube is irradiated onto human epidermal cells. The irradiation light is dispersed according to each given center wavelength using a band pass filter with a half band width of 40 nm. The ratio (base: the case where light is not irradiated) of the production amount of inflammatory cytokine is compared by center wavelength. The comparison result shows that the production ratio of inflammatory cytokine is at the minimum (most strongly reduced) at a center wavelength of 650 nm.

The above-described results prove that inflammatory diseases can be treated with a new mechanism by irradiating light of an appropriate wavelength to prevent the production of inflammatory cytokine.

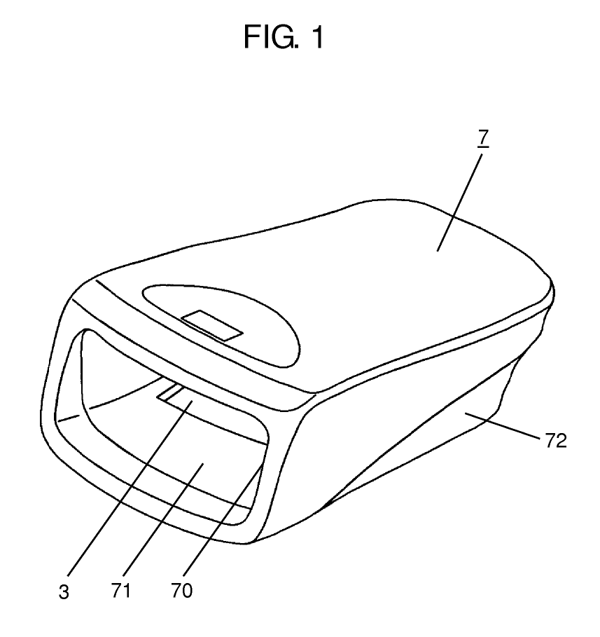

Hereinafter, a description is made of a light projection treatment and prevention device, which is an example of a light projection device according to the first embodiment of the present invention, using FIGS. 1 through 3. A detailed description of the reflector, a feature of this exemplary embodiment, is made after the description of the general configuration of the light projection treatment and prevention device.

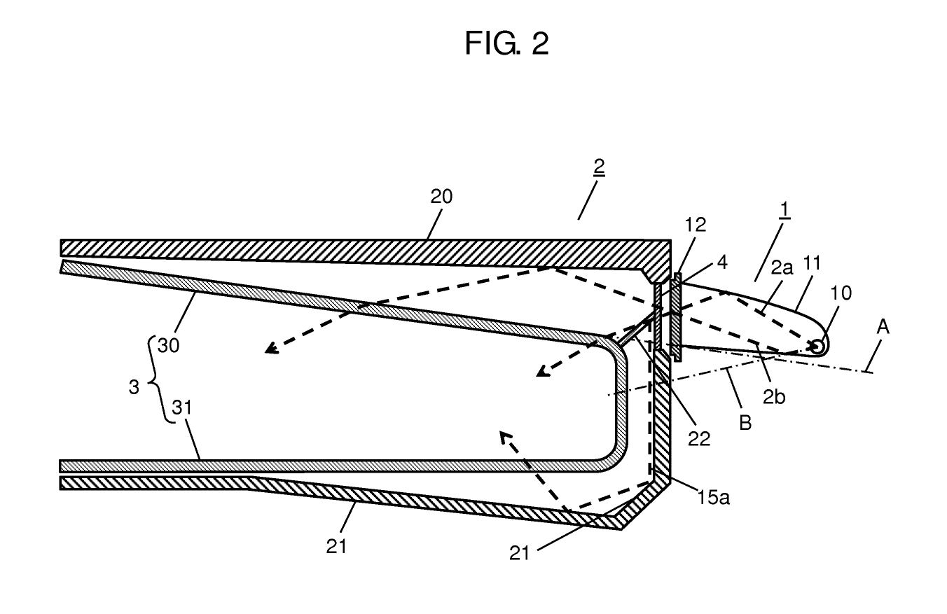

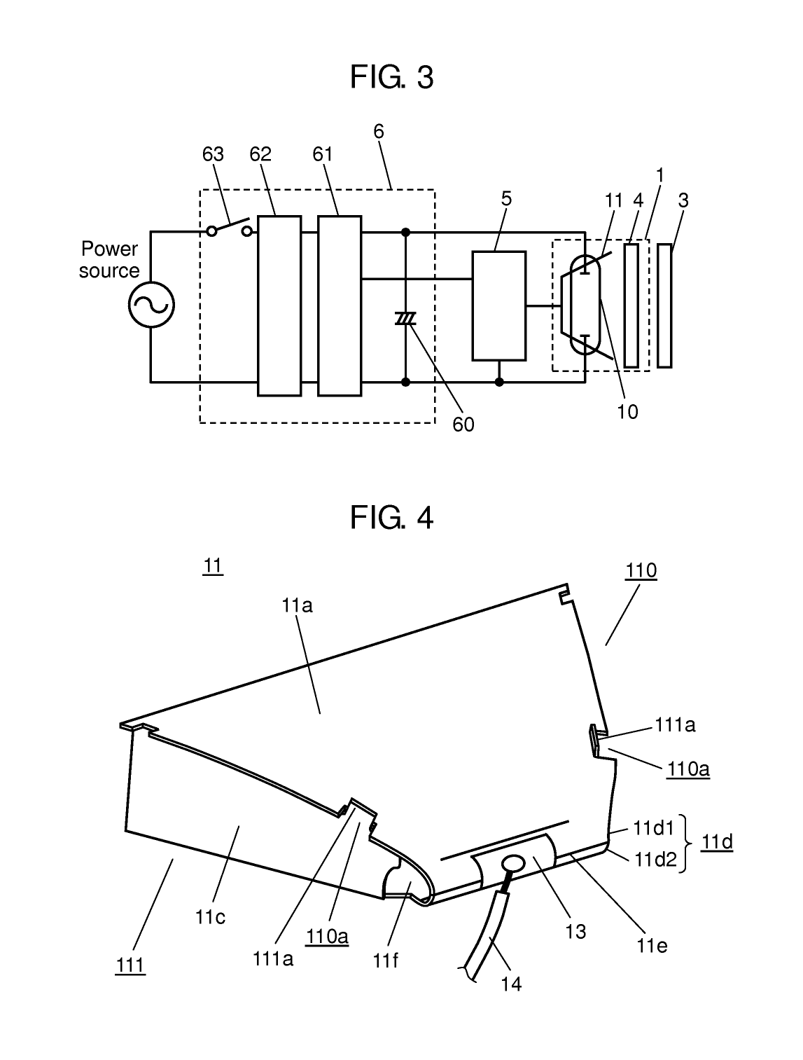

FIG. 1 is an entire perspective view of a light projection treatment and prevention device according to the first exemplary embodiment of the present invention. FIG. 2 is a substantial part sectional view of the light projection treatment and prevention device according to the same exemplary embodiment of the present invention. FIG. 3 is a block diagram of the light projection treatment and prevention device according to the same exemplary embodiment of the present invention.

A description is made of the light projection treatment and prevention device of this exemplary embodiment as an example of a light projection device mainly used for preventing and relieving inflammatory diseases.

First, as shown in FIGS. 1 through 3, a light projection treatment and prevention device of this exemplary embodiment includes at least light emitting unit 1 radiating radiation light, reflection unit 2, light guide unit 3, wavelength transmitting unit 4, light emission control unit 5, power supply unit 6, and casing 7. Reflection unit 2 reflects radiation light radiated from light emitting unit 1, toward light guide unit 3. Light guide unit 3 transmits reflection light reflected by reflection unit 2 and light-guides the reflected light to an irradiation target body (not shown). Wavelength transmitting unit 4 transmits radiation light in a specific wavelength range among those radiated from light emitting unit 1. Light emission control unit 5 controls light emission of light emitting unit 1. Power supply unit 6 supplies electricity to light emitting unit 1 and light emission control unit 5.

Casing 7 shown in FIG. 1 accommodates light emitting unit 1, reflection unit 2, light guide unit 3, wavelength transmitting unit 4, light emission control unit 5, and power supply unit 6, and has a structure capable of irradiating transmitted light (radiation light) transmitted from wavelength transmitting unit 4, toward a region where prevention is desired or an affected (specific) region.

Casing 7 has at least one opening. Casing 7 is formed in a substantially or completely rectangular parallelepiped shape incorporating light emitting unit 1, reflection unit 2, light guide unit 3, wavelength transmitting unit 4, light emission control unit 5, and power supply unit 6, for instance.

Casing 7 further includes at least placing unit 71 and grasping unit 72 grasped for carrying casing 7. Placing unit 71 is an armrest for instance on which a user's hand is placed that has been inserted through opening 70 formed in one surface (hereinafter, referred to as front surface) of casing 7 in order to irradiate radiation light of wavelengths in a specific range.

Next, a description is made of light emitting unit 1 accommodated in casing 7 using FIG. 2.

As shown in FIG. 2, light emitting unit 1 includes at least light source 10, reflector 11, and Fresnel lens 12. Fresnel lens 12 is attached to the opening of reflector 11 to adjust the incident angle of radiation light entering wavelength transmitting unit 4. Reflector 11, as described in detail later, is composed of at least first and second reflectors joined together.

In this case, light emitting unit 1 is placed farther away (the upper side in the figure) from an irradiation target body than from tangent A (in this exemplary embodiment, a straight line on the surface that is formed by extending first light guide surface 30 (flat) of light guide unit 3).

Light source 10 of light emitting unit 1 uses a flash discharge tube such as a xenon discharge tube or halogen discharge tube that irradiates radiation light of an appropriate wavelength to prevent the production of inflammatory cytokine, toward a region where prevention is desired or an affected (specific) region of a living body. In this exemplary embodiment, a description is made of an example where a xenon discharge tube is used for light source 10.

Reflector 11 of light emitting unit 1 reflects radiation light 2a for instance that heads farther away from the side of light guide unit 3 opposite to an irradiation target body than from tangent A that touches first light guide surface 30 of light guide unit 3, toward reflection unit 2 or light guide unit 3. In the same way, reflector 11 reflects radiation light 2b for instance that heads toward tangent A (i.e., the side of light guide unit 3 closer to an irradiation target body), toward reflection unit 2 or light guide unit 3.

Fresnel lens 12 is provided when wavelength transmitting unit 4 uses a filter that has incident angle dependence for instance. In this case, Fresnel lens 12 is placed so that the incident angle of light from light source 10 is within an allowable incident angle of wavelength transmitting unit 4 to be used. When wavelength transmitting unit 4 uses a color glass filter that has no incident angle dependence for instance, Fresnel lens 12 may be omitted.

Next, a description is made of reflection unit 2 and light guide unit 3 that guide radiation light radiated from light emitting unit 1, toward an irradiation target body using FIG. 2.

As shown in FIG. 2, reflection unit 2 controls the range of radiation light radiated substantially or completely omnidirectionally from light source 10 so that radiation light that has been transmitted through wavelength transmitting unit 4 irradiates toward a region where prevention is desired or an affected (specific) region.

Reflection unit 2 of this exemplary embodiment includes first reflection unit 20 that reflects radiation light emitted from light emitting unit 1, toward first light guide surface 30 of light guide unit 3; third reflection unit 22 that reflects part of radiation light radiated from light emitting unit 1, toward second reflection unit 21; and second reflection unit 21 that reflects radiation light reflected on third reflection unit 22, toward second light guide surface 31 that is different from first light guide surface 30 of light guide unit 3.

In this case, first reflection unit 20 of reflection unit 2 is placed facing first light guide surface 30 of light guide unit 3. They are placed so that their gap is narrower with their distance from light emitting unit 1. In other words, the optical path length between the reflecting surface of first reflection unit 20 and first light guide surface 30 of light guide unit 3 is shorter with the distance of the position where light guide unit 3 transmits reflection light, from light emitting unit 1. Concretely, in this exemplary embodiment, first reflection unit 20 of reflection unit 2 is placed horizontally, and first light guide surface 30 of light guide unit 3 is placed obliquely so that the distance between first light guide surface 30 and first reflection unit 20 of reflection unit 2 is shorter (narrower) from light emitting unit 1 toward its opposite side (the left side in the figure), for instance. Here, first reflection unit 20 is formed substantially or completely continuously from reflector 11 of light emitting unit 1 to the end of first light guide surface 30 opposite to light emitting unit 1.

Meanwhile, second reflection unit 21 of reflection unit 2 is placed opposite to first reflection unit 20 with first light guide surface 30 and second light guide surface 31 both composing light guide unit 3 interposed. The gap between second reflection unit 21 of reflection unit 2 and second light guide surface 31 of light guide unit 3 is narrower with the distance from light emitting unit 1. In other words, the optical path length between the reflecting surface of second reflection unit 21 and second light guide surface 31 of light guide unit 3 is shorter with the distance of the position where light guide unit 3 transmits reflection light, from light emitting unit 1. Concretely, in this exemplary embodiment, second light guide surface 31 of light guide unit 3 is placed horizontally, and second reflection unit 21 of reflection unit 2 is placed obliquely so that the distance between second reflection unit 21 of reflection unit 2 and second reflection unit 21 of light guide unit 3 is shorter (narrower) from light emitting unit 1 toward its opposite side (the left side in the figure), for instance. Here, the inclination of second reflection unit 21 of reflection unit 2 is formed halfway through second light guide surface 31 of guide unit 3, but clearly not limited to this case. This is because the light projection device of this exemplary embodiment is designed to irradiate radiation light distinctively toward the outer or inner side of a hand. That is, inflammatory cytokine is produced on a palm to a small degree, and thus the light projection device does not irradiate light toward the palm.

Further, as shown in FIG. 2, third reflection unit 22 of reflection unit 2 is placed so as to bridge between light guide unit 3 and wavelength transmitting unit 4 for instance, using a reflective plate that reflects radiation light radiated from light source 10 of light emitting unit 1. Then, third reflection unit 22 is placed obliquely with respect to Fresnel lens 12 composing light emitting unit 1 and to wavelength transmitting unit 4 provided on reflection unit 2. In other words, third reflection unit 22 is placed so that its tip close to wavelength transmitting unit 4 is oblique at a given angle (e.g., 45 degrees) with respect to wavelength transmitting unit 4, toward light emitting unit 1, around the axis orthogonal to the direction from light emitting unit 1 toward first reflection unit 20. Concretely, third reflection unit 22 is formed of a reflective plate partly provided with a slit or notch for instance in third reflection unit 22 close to Fresnel lens 12.

This structure allows third reflection unit 22 formed of the reflective plate to reflect part of radiation light radiated from light emitting unit 1 toward second reflection unit 21 and to transmit the rest toward first reflection unit 20.

Further, as shown in FIG. 2, light guide unit 3 includes first light guide surface 30 and second light guide surface 31 each placed facing the other. In this exemplary embodiment, first light guide surface 30 is placed facing the back (the outer side of the hand from the wrist to the fingertips) of a user's hand. Meanwhile, second light guide surface 31 is placed facing the palm (the inner side of the hand from the wrist to the fingertips) of a user's hand.

Wavelength transmitting unit 4 of this exemplary embodiment is placed closer to light emitting unit 1 than from third reflection unit 22 of reflection unit 2, on the optical path of radiation light radiated from light emitting unit 1 toward first reflection unit 20 of reflection unit 2. Here, wavelength transmitting unit 4 is formed of an optical filter through which radiation light of only one or more specific wavelength or only one or more specific wavelength ranges in radiation light from light emitting unit 1 transmits.

Concretely, wavelength transmitting unit 4 is formed of a band pass filter (interference filter) that transmits radiation light of a wavelength between 566.5 nm and 780 nm (inclusive), favorably between 566.5 nm and 746 nm (inclusive), and more favorably between 600 nm and 700 nm (inclusive).

Next, a detailed description is made of light emission control unit 5 for controlling the light emission of light emitting unit 1, and power supply unit 6, using FIG. 3.

Light emission control unit 5 shown in FIG. 3 controls the light emission of light emitting unit 1 according to the light-emitting pattern shown later. For example, light emission control unit 5 makes light emitting unit 1 flash one time or multiple times separately. When flashing is made multiple times separately, it may be made with radiation energy radiated from light emitting unit 1 lower than a given radiation energy level. Further, light emission control unit 5 controls light emitting unit 1 so that it emits light at given intervals for instance.

Power supply unit 6 shown in FIG. 3 includes electricity storage unit 60, charging circuit 61, power supply unit 62, and power switch 63 for switching between on and off of power supply unit 62. Power supply unit 6 is used as power supply for light emission control unit 5 besides light emitting unit 1.

Electricity storage unit 60 has an electric capacity high enough to make light emitting unit 1 emit light for instance; formed of a main capacitor connected in parallel with light source 10; and stores light emission energy of light emitting unit 1. Charging circuit 61 charges electricity storage unit 60 with electricity supplied through power supply unit 62.

A light projection treatment and prevention device as an example of a light projection device of this exemplary embodiment is structured as described hereinbefore.

Hereinafter, a detailed description is made of reflector 11, a feature of this exemplary embodiment, using FIGS. 4 through 6.

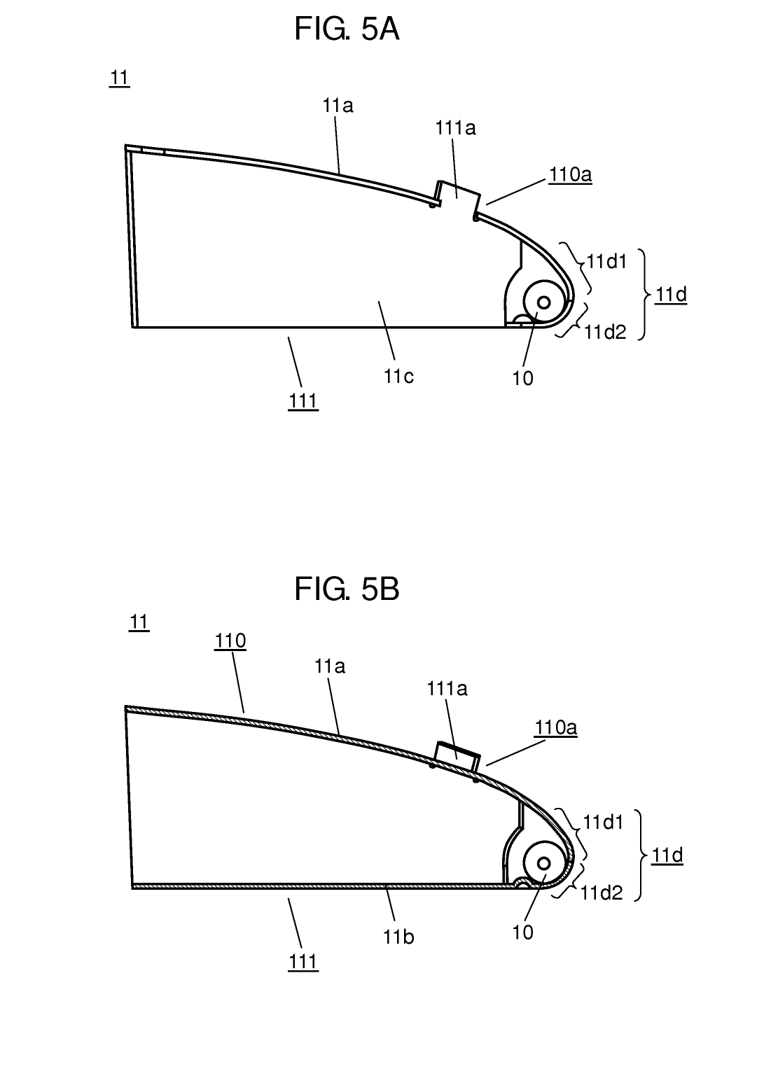

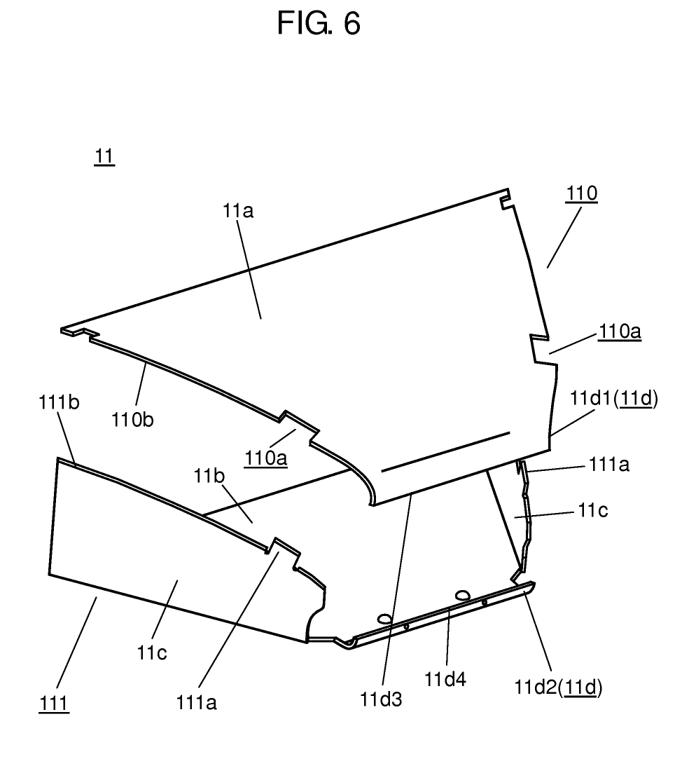

FIG. 4 is a perspective view of the reflector of the light projection treatment and prevention device according to the same exemplary embodiment. FIG. 5A is a side view of the reflector of the light projection treatment and prevention device according to the same exemplary embodiment. FIG. 5B is a sectional side view of the reflector of the light projection treatment and prevention device according to the same exemplary embodiment. FIG. 6 is an exploded perspective view of the reflector of the light projection treatment and prevention device according to the same exemplary embodiment.

As shown in FIGS. 4 through 6, reflector 11 of this exemplary embodiment is composed of at least two divided parts: first reflector 110 and second reflector 111, which include as a whole top surface 11a, bottom surface 11b, a pair (right and left) of side surfaces 11c, and innermost surface 11d where light source (flash discharge tube) 10 is placed. First reflector 110 and second reflector 111 are formed of a metallic material such as aluminum (Al), and its inner surface in which a flash discharge tube is contained is at least formed in a mirror surface with high reflectivity. Innermost surface 11d has a curved surface substantially or completely identical to the external diameter of the flash discharge tube through approximately a half of the whole circumference. This increases the contact surface area between the flash discharge tube and reflector 11 to reduce the contact resistance.

In this case, as shown in FIG. 4, first reflector 110 and second reflector 111 are at least integrally formed at joint 11e formed on innermost surface 11d of reflector 11.

Concretely, as shown in FIG. 6, first reflector 110 is composed of top surface 11a and part 11d1 of innermost surface 11d integrally formed. Meanwhile, second reflector 111 is composed of bottom surface 11b, a pair (right and left) of side surfaces 11c, and part of the rest 11d2 of innermost surface 11d integrally formed.

First reflector 110 is provided with engaged part 110a such as a notch (cutout) that has been notched inward from both (right and left) side edges of top surface 11a. Meanwhile, second reflector 111 is provided with engaging part 111a such as a protrusion piece that protrudes upward from each top edge 111b of a pair (right and left) of side surfaces 11c.

Then, as shown in FIG. 4, engaging part 111a (i.e., the protrusion piece of second reflector 111) is inserted into engaged part 110a (i.e., the notch of first reflector 110). This makes top edges 111b of the pair (right and left) of side surfaces 11c of second reflector 111 and top edge 11d4 of part of the rest 11d2 of innermost surface 11d are integrated with bottom surface 110b of top surface 11a of first reflector 110 and bottom surface 11d3 of part 11d1 of innermost surface 11d in a state where both the top edges and the bottom surfaces are substantially or completely in contact with each other.

Further, as shown in FIG. 4, fixing material 13 (refer to FIG. 4), having conductivity, such as a conductive tape, is applied across joint 11e between first reflector 110 and second reflector 111 to fix them, thereby reliably fixing them and joining them together by means of fixing material 13.

Then, the conductive tape (i.e., fixing material 13) has trigger lead wire 14 connected thereto by soldering for instance.

The above process provides the structure of reflector 11 of a light projection treatment and prevention device as an example of a light projection device of this exemplary embodiment.

As described hereinbefore, this exemplary embodiment, where reflector 11 is divided into two parts: first reflector 110 and second reflector 111, allows the two parts to be individually molded.

Herewith, with a light projection device of this exemplary embodiment, first reflector 110 and second reflector 111 can be molded precisely and easily even for reflector 11 that is large (long) in depth (the direction in which light is irradiated). This provides reflector 11 in a simple structure by joining first reflector 110 and second reflector 111 together appropriately without looseness.

In this exemplary embodiment, first reflector 110 and second reflector 111 are connected with each other and fixed by means of fixing material 13 made of a conductive tape. This allows first reflector 110 and second reflector 111 to have the same electric potential owing to fixing material 13. This prevents sparks if a trigger voltage is applied between first reflector 110 and second reflector 111. This prevents first reflector 110 and second reflector 111 to be separated from each other, which preliminarily stops looseness and positional deviation over a long term, thereby providing a highly reliable light projection device.

In this exemplary embodiment, the conductive tape as fixing material 13 has trigger lead wire 14 connected thereto by soldering. This allows the reflector composed of first and second reflectors to be trigger electrodes easily. Further, when trigger lead wire 14 is removed from the reflector for replacement, the conductive tape simply needs to be removed from the reflector, which simplifies the replacement work. When reflector 11 is made of aluminum for instance, an oxide film is formed on its surface, which sometimes makes it difficult to directly solder trigger lead wire 14 onto reflector 11. The above structure, however, does not need heating for a long time for connection, which preliminarily stops deformation of reflector 11 for instance, thereby providing highly reliable connection.

A light projection device of the present invention is not limited to the above-described exemplary embodiments, but clearly, various types of modifications may be added within a scope that does not deviate from the gist of the present invention.

For example, in the above-described exemplary embodiment, the description is made of the example where reflector 11 is divided into the two parts: first reflector 110 and second reflector 111, but not limited to this case. The reflector may be divided into three or more parts.

In the above-described exemplary embodiment, the description is made of the example where second reflector 111 is provided with a pair (right and left) of side surfaces 11c, but not limited to this case. For example, first reflector 110 may be provided with a pair (right and left) of side surfaces 11c. Moreover, the following structure may be used. That is, one of the pair of side surfaces 11c is provided at first reflector 110; and the other, at second reflector 111.

In the above-described exemplary embodiment, the description is made of the example where part 11d1 of innermost surface 11d is provided at first reflector 110; and part of the rest 11d2, at second reflector 111, but not limited to this case. For example, the following structure may be used. That is, innermost surface 11d is not divided, but is provided only at one side: first reflector 110 or second reflector 111.

In the above-described exemplary embodiment, the description is made of the example where fixing material 13 is formed of a conductive tape, but not limited to this case. For example, conductive thermosetting resin or conductive photosetting resin may be used.

In the above-described exemplary embodiment, the description is made of the example where first reflector 110 is provided with engaged part 110a that is a notch, but not limited to this case. For example, engaged part 110a may be a slit into which engaging part 111a that is a protrusion piece of second reflector 111 is inserted, which more reliably joins first reflector 110 and second reflector 111 together.

### Second Exemplary Embodiment

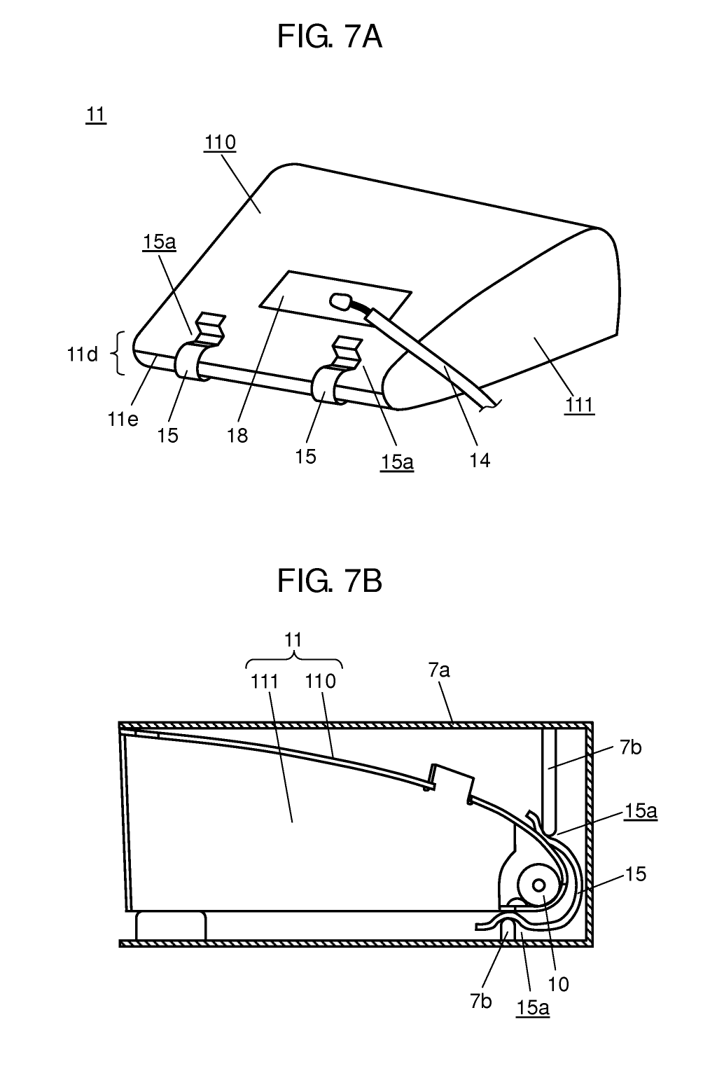

Hereinafter, a description is made of a light projection device according to the second exemplary embodiment of the present invention using FIGS. 7A and 7B. The description and drawing are omitted of a component and effect same as those of the light projection device of the first exemplary embodiment. For drawings, a description is made of a light projection treatment and prevention device as an example of a light projection device in the same way as in the first exemplary embodiment.

FIG. 7A is an entire perspective view of the reflector of a light projection treatment and prevention device according to a second exemplary embodiment of the present invention. FIG. 7B is a cross-sectional side view of the light projection treatment and prevention device, illustrating a state where the reflector is accommodated in the casing according to the second exemplary embodiment of the present invention.

As shown in FIGS. 7A and 7B, reflector 11 of the light projection treatment and prevention device of this exemplary embodiment is different from the first exemplary embodiment in that the vicinity of the joint between the first and second reflectors is fixed using a holding body having an elastic piece as fixing material 15. The other components are basically same as those of the first exemplary embodiment, and thus each of them is given the same reference mark to omit its description.

As shown in FIGS. 7A and 7B, fixing material 15 is formed of a substantially or completely C-shaped holding body including a pair of elastic pieces 15a, having conductivity, such as stainless-steel (SUS). Elastic pieces 15a of the holding body elastically holds first reflector 110 and second reflector 111 through joint 11e. That is, fixing material 15 formed of a holding body works as a kind of clip. In this exemplary embodiment, elastic pieces 15a form a concave (recess) shape.

Concretely, as shown in FIG. 7A, the gap between the pair of elastic pieces 15a facing each other is expanded, and the holding body is attached holding the vicinity of joint 11e between first reflector 110 and second reflector 111. At this moment, each of the pair of elastic pieces 15a elastically displaces toward (the direction in which reflector 11 is sandwiched) the other, which allows joint 11e between first reflector 110 and second reflector 111 to be elastically held with fixing material 15 formed of a holding body.

Then, as shown in FIG. 7A, conductive tape 18 with trigger lead wire 14 soldered thereto for instance is applied onto reflector 11 for fixing, thereby electrically connecting trigger lead wire 14 with reflector 11, which works as trigger electrodes. To elastically hold reflector 11 with fixing material 15 formed of a holding body, however, fixing material 15 is easily detached from reflector 11 since innermost surface 11d of reflector 11 is curved.

Hence, as shown in FIG. 7B, this exemplary embodiment includes at least locking part 7b accommodating light emitting unit 1, and reflector 11 of the above-described structure is inserted into casing 7a partially forming casing 7 for instance for fixing.

Concretely, locking parts 7b on casing 7a are provided in a pair correspondingly to the position of the concave part of the pair of elastic pieces 15a of the holding body as fixing material 15, and locks the pair of elastic pieces 15a of the holding body. In other words, the tip of locking part 7b is caught into the concave part of elastic pieces 15a for locking.

This prevents fixing material 15 formed of a holding body from being detached in a state where the vicinity of joint 11e between first reflector 110 and second reflector 111 is elastically held.

This exemplary embodiment elastically hold joint 11e between first reflector 110 and second reflector 111 with fixing material 15 formed of a holding body, while preventing fixing material 15 from being detached from reflector 11 by means of locking part 7b on casing 7a. This prevents separation between first reflector 110 and second reflector 111, and stops looseness and positional deviation.

With this exemplary embodiment, fixing material 15 formed of a holding body is provided across joint 11e between first reflectors 110 and second reflector 111. This allows first reflector 110 and second reflector 111 to have the same electric potential, which preliminarily stops sparks that are likely to be generated between first reflector 110 and second reflector 111, thereby providing a light projection device that is highly reliable for a long term.

In this exemplary embodiment, as shown in FIG. 7A, the description is made of the example where conductive tape 18 with trigger lead wire 14 soldered thereto is applied onto first reflector 110 forming reflector 11, but not limited to this case. For example, in the same way as the first exemplary embodiment, conductive tape 18 may be applied across joint 11e between first reflector 110 and second reflector 111. In this case, joint 11e between first reflector 110 and second reflector 111 can be fixed using two different types of fixing materials 13 and 15. This further prevents separation between first reflector 110 and second reflector 111, and stops looseness and positional deviation.

### Third Exemplary Embodiment

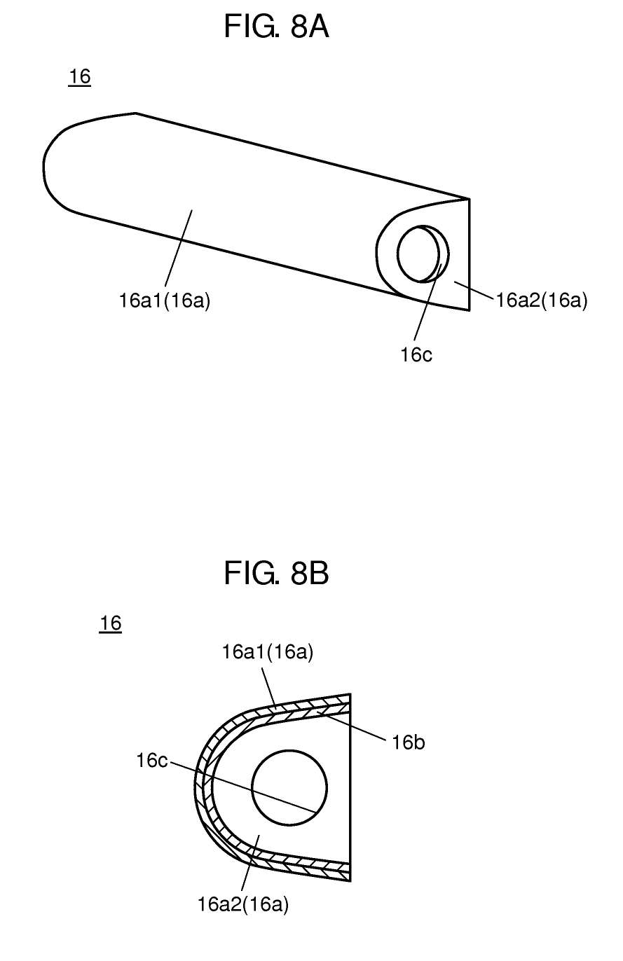

Hereinafter, a description is made of a light projection device according to a third exemplary embodiment of the present invention using FIGS. 8A and 8B. Description is omitted of a component and effects same as those of the light projection device of the first exemplary embodiment. In the same way as in the first exemplary embodiment, a description is made of a light projection treatment and prevention device as an example of a light projection device.

FIG. 8A is a perspective view of a cap used for the light projection treatment and prevention device according to a third exemplary embodiment. FIG. 8B is a cross-sectional side view of the cap used for the light projection treatment and prevention device according to the third exemplary embodiment.

As shown in FIGS. 8A and 8B, a light projection treatment and prevention device of this exemplary embodiment is different from the first exemplary embodiment in that the vicinity of the joint between the first and second reflectors is fixed using a cap instead of a conductive tape as a fixing material. The other components are basically same as those of the first exemplary embodiment.

As shown in FIGS. 8A and 8B, the cap as fixing material 16 is composed of cap body 16a made of an elastic material such as ABS or polycarbonate; and conductive layer 16b formed on the inner surface of cap body 16a and made of a conductive sheet for instance.

Cap body 16a is composed of circumferential surface 16a1 covering innermost surface 11d of reflector 11 from its outer surface; and side surface 16a2 formed at the side of circumferential surface 16a1.

Further, side surface 16a2 of cap body 16a has insertion hole 16c formed therein into which flash discharge tube 10 is inserted. In this case, insertion hole 16c is formed in a diameter substantially or completely same as that of flash discharge tube 10, preferably smaller. Then, flash discharge tube 10 can be fixed by means of insertion hole 16c with flash discharge tube 10 pressured against innermost surface 11d of reflector 11.

Hereinafter, a description is made of how the cap is attached that is fixing material 16 for fixing joint 11e of reflector 11 composed of first reflector 110 and second reflector 111, referring to FIG. 4.

First, as shown in FIG. 4, join first reflector 110 and second reflector 111 together, and fit the cap to joint 11e between the first reflector 110 and second reflector 111 from the outside.

Next, insert flash discharge tube 10 into one end of insertion hole 16c provided in side surface 16a2 and expose one end of flash discharge tube 10 from the other end of insertion hole 16c.

At this moment, position insertion hole 16c of the cap attached onto reflector 11 closer to the inner surface (joint 11e) side of innermost surface 11d than the position where flash discharge tube 10 is attached at the inner surface side of innermost surface 11d of reflector 11. In this case, flash discharge tube 10 inserted into insertion hole 16c of the cap is drawn toward the inner surface of innermost surface 11d of reflector 11 due to an elastic force of cap body 16a. This allows the cap to fix flash discharge tube 10 in close contact with the inner surface of innermost surface 11d of reflector 11. Accordingly, the cap as fixing material 16 functions as a bushing as well.

With this exemplary embodiment, as a result that the cap as a fixing material is externally fitted to the joint between the first reflector and the second reflector, the joint can be held, which prevents first reflector 110 and second reflector 111 from being separated from each other, thereby joining first reflector 110 and second reflector 111 together appropriately without looseness in a simple structure.

With this exemplary embodiment, the cap having a conductive layer provided on the inner surface of the cap is placed across the joint between the first and second reflectors. This allows first reflector 110 and second reflector 111 to have the same electric potential through the conductive layer. This preliminarily stops sparks that are likely to be generated between first reflector 110 and second reflector 111, thereby providing a light projection device that is highly reliable for a long term.

With this exemplary embodiment, the conductive layer is formed of a conductive sheet, which allows the conductive layer to be formed by a simple work.

With this exemplary embodiment, the flash discharge tube is reliably fixed owing to elastic deformation of the cap body, which prevents looseness of the flash discharge tube and facilitates positioning it.

With this exemplary embodiment, as shown in FIG. 4, side surface 11c of reflector 11 close to innermost surface 11d has opening 11f larger than flash discharge tube 10 formed therein to let flash discharge tube 10 be inserted. Even so, the above-described opening 11f covered with side surface 16a2 of the cap as fixing material 16 prevents leakage of radiation light radiated from the flash discharge tube and ingress of light into the light projection device.

As described hereinbefore, a light projection device of the present invention includes a flash discharge tube and a reflector into which the flash discharge tube is inserted. The reflector is composed of at least a first reflector and a second reflector, where at least the joint between the first reflector and the second reflector is fixed with a conductive fixing material.

With this structure, even if the reflector is divided into first and second reflectors, they can be joined together with a conductive fixing material. Accordingly, a gap is not formed at the joint even if there are dimensional variations between the first reflector and the second reflector, which are joined together appropriately without looseness. This structure prevents looseness between the first reflector and the second reflector and facilitates positioning between them, thereby providing a light projection device capable of achieving stable optical performance.

Further, a conductive fixing material is provided at least across the joint between the first and second reflectors, bringing them into electrical conduction, which makes the first reflector and the second reflector have the same electric potential. This prevents sparks between the first reflector and the second reflector even if a trigger voltage is applied using the reflector composed of the first reflector and the second reflector as trigger electrodes, thereby providing a highly reliable light projection device.

In the light projection device of the present invention, its fixing material is a conductive tape applied to the joint.

This structure allows the reflector composed of first and second reflectors to be joined together appropriately without looseness. Further, the conductive tape is provided across the first reflector and the second reflector, which easily makes them have the same electric potential.

In the light projection device of the present invention, the conductive tape has a trigger lead wire soldered thereto.

This structure allows the reflector composed of first and second reflectors to be trigger electrodes through the conductive tape easily. Further, when the trigger lead wire is removed from the reflector for replacement, the conductive tape simply needs to be removed from the reflector, which simplifies the replacement work.

In the light projection device of the present invention, the fixing material is formed of a holding body having at least a pair of elastic pieces, which elastically hold the joint.

With this structure, at least a pair of elastic pieces elastically holds the joint between the first reflector and second reflector, namely the joint where the first reflector and the second reflector are joined together. This makes a holding body hold the first reflector and the second reflector, which prevents the first reflector and the second reflector from being separated from each other, thereby joining them together appropriately without looseness in a simple structure. Further, the holding body is provided across the joint between the first reflector and the second reflector, which makes them have the same electric potential.

The light projection device of the present invention includes a casing accommodating the flash discharge tube and the reflector, and the casing has a locking part that locks the holding body.

With this structure, the locking part of the casing locks the holding body in a state where the holding body elastically holds the joint between the reflectors, which prevents the holding body from being separated from the joint between the first reflector and the second reflector. This prevents separation between the first reflector and the second reflector, and preliminarily stops looseness and sparks, thereby providing a highly reliable light projection device.

The light projection device of the present invention has a cap as a fixing material that is externally fitted to the joint and has an insertion hole into which the flash discharge tube is inserted.

With this structure, the joint between the first and second reflectors is held by externally fitting the cap to the joint, which prevents the first reflector and the second reflector from being separated from each other. In other words, in the same way as with a conductive tape or a holding body, the first and second reflectors are joined together appropriately without looseness in a simple structure. Further, the cap is provided across the joint between the first reflector and the second reflector, which makes them have the same electric potential.

In the light projection device of the present invention, the cap includes a cap body; and a conductive layer formed on the inner surface of the cap body.

With this structure, a conductive layer is formed on the inner surface of the cap body. With this structure, when the cap is externally fitted to the joint between the first reflector and the second reflector, the conductive layer of the cap is provided across the first reflector and the second reflector, which makes them have the same electric potential through the conductive layer.

In the light projection device of the present invention, the conductive layer is formed of a conductive sheet.

This structure allows the conductive layer of the cap to be formed easily by a simple work.

In the light projection device of the present invention, the cap body is formed of an elastic material.

This structure allows the flash discharge tube to be reliably fixed owing to elastic deformation of the cap body, which prevents looseness of the flash discharge tube and facilitates positioning it.

### INDUSTRIAL APPLICABILITY

The present invention allows divided reflectors to be joined together appropriately, and thus is useful in the technical field of light projection devices for instance where a reflector is requested that is large (long) in the direction of light projection in order to extensively distribute light from the flash discharge tube.

### REFERENCE MARKS IN THE DRAWINGS

1 Light emitting unit
2 Reflection unit
2a, 2b Radiation light
3 Light guide unit
4 Wavelength transmitting unit
5 Light emission control unit
6 Power supply unit
7, 7a Casing
7b Locking part
10 Flash discharge tube (light source)
11 Reflector
11a Top surface
11b Bottom surface
11c Side surface
11d Innermost surface
11d1 Part
11d2 Part of the rest
11d3, 110b Bottom surface
11d4, 111b Top edge
11e Joint
11f Opening
12 Fresnel lens
13, 15, 16 Fixing material
14 Trigger lead wire
15a Elastic piece
16a Cap body
16a1 Circumferential surface
16a2 Side surface
16b Conductive layer
16c Insertion hole
18 Conductive tape
20 First reflection unit
21 Second reflection unit
22 Third reflection unit
30 First light guide surface
31 Second light guide surface
60 Electricity storage unit
61 Charging circuit
62 Power supply unit
63 Power switch
70 Opening
71 Placing unit
72 Holding unit
110 First reflector
110a Engaged part
111 Second reflector
111a Engaging part

1. A light projection device comprising:
a flash discharge tube; and
a reflector into which the flash discharge tube is disposed,
wherein the reflector includes at least a first reflector and a second reflector, and
wherein at least a joint between the first reflector and the second reflector is fixed with a conductive fixing material.

2. The light projection device of claim 1, wherein the fixing material is a conductive tape applied to the joint.

3. The light projection device of claim 2, wherein a trigger lead wire is soldered to the conductive tape.

4. The light projection device of claim 1, wherein the fixing material includes a holding body having at least a pair of elastic pieces, the elastic pieces elastically holding the joint.

5. The light projection device of claim 4, further comprising a casing accommodating the flash discharge tube and the reflector, wherein the casing has a locking part locking the holding body.

6. The light projection device of claim 1, wherein the fixing material is formed of a cap that is externally fitted to the joint and has an insertion hole into which the flash discharge tube is inserted.

7. The light projection device of claim 6, wherein the cap includes a cap body and a conductive layer formed on an inner surface of the cap body.

8. The light projection device of claim 7, wherein the conductive layer is a conductive sheet.

9. The light projection device of claim 7, wherein the cap body is formed of an elastic material.
